(19) United States
(12) Patent Application Publication
(10) Pub. No.: US 2006/0274658 A1
(43) Pub. Date: Dec. 7, 2006

(54) Prereservation of resources for connecting paths in a packet-address-switched or label-switched communication network

(75) Inventors: Dominique Verchere, Breuillet (FR); Steffen Brockmann, Moglingen (DE); Martin Vigoureux, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/440,043

(22) Filed: May 25, 2006

(30) Foreign Application Priority Data
Jun. 2, 2005 (FR) 0551468

(51) Int. Cl. H04J 3/14

(52) U.S. Cl. 370/238; 370/396

(57) ABSTRACT

A node for a packet-address-switched or label-switched communication network comprises i) signaling means responsible for exchanging signaling messages with other nodes of the network in order to reserve resources of connecting paths each associated with a connection identifier and beginning at the node, and ii) control means responsible for, on the one hand, forming intervals of use of connecting paths to be set up between the node and at least one output node and, on the other hand, for commanding the signaling means to transmit to nodes that will have to participate in each of the connecting paths to be set up signaling messages containing connection identifiers of the connecting paths in which they have to participate and programming data representing their respective intervals of use and requesting them to prereserve resources at the level of their control plane necessary for setting up the connecting paths during time ranges that are a function of the intervals of use.

### CROSS-REFERENCE TO RELATED APPLICATIONS

This application is based on French Patent Application No. 0551468 filed Feb. 6, 2005, the disclosure of which is hereby incorporated by reference thereto in its entirety, and the priority of which is hereby claimed under 35 U.S.C. §119.

### BACKGROUND OF THE INVENTION

1. Field of the Invention

The invention relates to networks using connecting path resource reservation mechanisms, and in particular packet-address-switched networks (for example Internet Protocol (IP) networks) and label-switched networks having a MultiProtocol Label Switching (MPLS) or Generalized MPLS (GMPLS) architecture.

2. Description of the Prior Art

As the person skilled in the art knows, in the networks cited above, and in label-switched networks in particular, the reservation of the resources necessary for setting up and using a connecting path (for example a label-switched path (LSP)), begins when a request to set up said connecting path is transmitted by the source node that requires the setting up of said path to the output (or destination) node and to any intermediate nodes participating in said connecting path.

A set-up request includes a definition of the resources that are necessary for setting up and using a connecting path and is transmitted by means of a signaling message conforming to the RSVP-TE signaling protocol (ReSerVation Protocol—Traffic Engineering), for example.

Reservation of the resources used to set up a connecting path begins on receipt of a set-up request and is effected at two different levels: the control plane level and the data plane level. Reservation at the control plane level is of the software type. Reservation at the data plane level is of the hardware type and necessitates assignment of actual resources and therefore configuration of the routing matrices of the nodes of the connecting path.

There is no guarantee that the resources needed to set up and use a connecting path will be available at the data plane level at the time a request is transmitted. If the resources are unavailable, the connecting path concerned cannot be set up, which may be a problem for the user.

Thus one object of the invention is to solve the problem cited above.

### SUMMARY OF THE INVENTION

To this end the invention proposes a node for a packet-address-switched or label-switched communication network having a (G)MPLS architecture comprising signaling means responsible for exchanging signaling messages with other label-switched nodes (of the network) in order to reserve resources of connecting paths each associated with a connection identifier and beginning at their node.

The packet-address-switched or label-switched node comprises control means responsible, on the one hand, for forming intervals of use of connecting paths to be set up between their node and at least one output node (of the network) and, on the other hand, for commanding the signaling means to transmit to nodes that will have to participate in each of the connecting paths to be set up signaling messages containing connection identifiers of the connecting paths in which they have to participate and programming data representing their respective intervals of use (for example time intervals) and requesting them to prereserve resources at the level of their control plane needed for setting up the connecting paths during time ranges that are a function of the intervals of use.

In the present context, the term “prereserve” refers to reserving resources in advance, i.e. at a given time.

By programming the reservation in each node having to participate in connecting paths of the ranges of use of the resources necessary for setting them up and using them, it is virtually certain, when the set-up request in respect of one of the connection paths is transmitted, that the corresponding resources can be assigned to it within a known time period.

The packet-address-switched or label-switched node of the invention may have other features, and in particular, separately or in combination:

its control means may be made responsible for defining either programming data representing setting up times of day and end of use times of day of each interval of use relative to a reference clock or programming data representing the required setting up time of day and the duration of use of each interval of use;

in the presence of connecting paths to be used at least partly simultaneously and in the event of local resources being insufficient for simultaneous use, its control means may be made responsible for setting up a hierarchy of connecting paths as a function of at least one selected criterion so as to place the ranges of use relative to each other as a function of the associated connecting path hierarchy between associated connecting paths;

its control means may be made responsible for establishing the hierarchy as a function of a quality of service (QoS) parameter associated with each connecting path, for example the priority level associated with the user of a connecting path;

its control means may instead be made responsible for establishing the hierarchy as a function of a criterion as to the order of arrival of the programming data relating to the different connecting paths;

its control means may be made responsible for defining the ranges of use by means of a flow-based queuing algorithm technique, for example the WFQ (Weighted Fair Queuing) or the WRED (Weighted Random Early Detection) technique;

its signaling means may be made responsible for integrating the programming data into a selected object of a signaling message;

the selected object may be either a pre-existing object or a new dedicated object.

The invention is particularly, although not exclusively, suitable for “packet-switched” (or “connection-oriented”) networks that have a MultiProtocol Label Switching (MPLS) architecture, for example ATM, Frame Relay (FR), IP and Ethernet networks, and for “circuit-switched” (or “non-packet” type) networks that have a GMPLS architecture, such as TDM networks (e.g. SONET/SDH, PDH, G.709), for example, wavelength-switched networks and space-switched networks (such as, for example, switching from an input port to an output port).

Other features and advantages of the invention will become apparent upon reading the following detailed description and examining the appended drawing.

### BRIEF DESCRIPTION OF THE DRAWING

FIG. 1 is a diagram of one example of a portion of a label switching communication network including a multiplicity of nodes conforming to the invention.

FIG. 2 is a diagram of one example of the distribution in time of ranges of use of connecting paths.

### DETAILED DESCRIPTION OF THE PREFERRED EMBODIMENT

The appended drawings constitute part of the description of the invention as well as contributing to the definition of the invention, if necessary.

An object of the invention is to enable prereservation of the resources needed to set up and use connecting paths in a network utilizing a resource reservation mechanism for connecting paths, for example a packet address or label switching network.

In the present context the term “prereservation” refers to reserving resources in advance, i.e. at a given time.

The network considered hereinafter by way of nonlimiting example is a label switching network of the IP type having a MultiProtocol Label Switching (MPLS) architecture. The invention is not limited to this type of packet-switched network, however. It relates to all packet networks having an MPLS architecture, and in particular ATM, Frame Relay (FR) and Ethernet networks, and likewise all circuit-switched (or “non-packet” type) networks that have a GMPLS architecture, such as TDM networks (e.g. SONET/SDH, PDH, G.709), for example, wavelength-switched networks and space-switched networks (such as switching from an input port to an output port, for example).

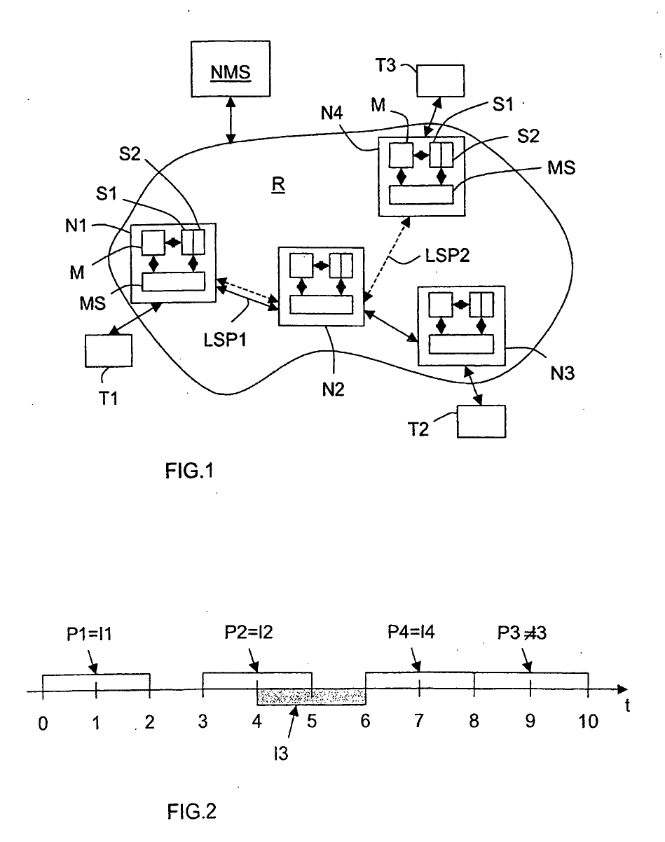

As indicated in the FIG. 1 diagram, a label-switched network (LSN) R comprises a multiplicity of network equipments constituting nodes Ni (here i=1 to 4, but i may take any value greater than or equal to 2). The nodes Ni are interconnected and are responsible for routing data packets (here of the IP type) to an output node of the network R.

Here the nodes Ni are what the person skilled in the art refers to as label switch routers (LSR), to be more precise IP/MPLS routers. However, in other applications they could be Ethernet switches, for example, SONET/SDH cross-connect units or G.709 optical cross-connect units.

Certain of these nodes Ni constitute what are referred to as input nodes (or “ingress nodes”), which here is the situation of the node N1, or output nodes (or “egress nodes”), which here is the situation of the nodes N3 and N4, while others constitute what are known as intermediate nodes, which here is the situation of the node N2.

These input and output nodes are placed at the two “extremities” of the network R and each may be connected to at least one network of users or businesses, represented in the diagram by terminals Tj (here j=1 to 3, but j may take any value). Moreover, an input node N1 is coupled to an output node N3 (or N4) via at least one connecting path (or label-switched path (LSP)) LSP1 (or LSP2) each defining a virtual connection (or “LSP tunnel”) passing through a set of nodes Ni of the network R. In the example represented in FIG. 1, the connecting path LSP1 is represented by the continuous double-headed arrows and the connecting path LSP2 is represented by the dashed double-headed arrows.

A “link” is a physical connection between two routers Ni (for example N1 and N2) and a “connecting path” (or LSP) is a path between an input router N1 and an output router N3 (or N4) defined by a sequence of physical links connecting two terminals (for example T1 and T2 (or T1 and T3)).

Each router Ni conventionally includes a signaling module MS for exchanging signaling messages with signaling modules MS installed in the intermediate routers (here router N2) and the output routers (here routers N3 and N4). Two main types of signaling message are used: path set-up request messages (“Path messages”) and reservation messages (“Resv messages”).

Path set-up request messages are generated by a signaling module MS in an input router N1 and are addressed to a signaling module MS in the output router N3 or N4. The reservation messages are generated by a signaling module MS in the output router N3 or N4 in response to receiving a path set-up request message and are addressed to a signaling module MS in the input router N1.

The signaling messages are transmitted in accordance with a signaling protocol such as the RSVP-TE protocol (ReSerVation Protocol—Traffic Engineering), for example. These messages include many objects (in turn consisting of one or more fields) that will not be explained in exhaustive detail here because they are familiar to the person skilled in the art.

Suffice to say that a path set-up request message includes in particular a SENDER_TEMPLATE object including an LSP ID field dedicated to the LSP identifier of a connecting path, a LABEL_SET object including a field dedicated to one or more label values that may be assigned to the connecting path and that must be excluded for said connecting path, and a SESSION_ATTRIBUTE object including a field specifying whether the resource reservation request is explicitly shared or not.

A reservation message is generated in response to this path set-up request and includes in particular a FILTER_SPEC object including an LSP ID field dedicated to the LSP identifier of the connecting path, a GENERALIZED_LABEL object including the value of the field assigned to the value of the label of the connecting path, and a STYLE object including the field dedicated to the type of resource reservation (fixed or shared).

The information contained in the signaling messages is stored for each signaling module MS in data structures. To be more precise, each router Ni includes storage means S1 and S2 in which are respectively stored first data structures known as path state blocks (PSB) containing data defining each connecting path of which it forms part and second data structures known as reservation state blocks (RSB) including data relating to the resource reservation status of each connecting path of which it forms part.

Each signaling message received by a node Ni is used to update one of its first data structures PSB and the associated second data structure RSB.

The invention proposes to add to the signaling module MS of at least some of the routers Ni of the network R, and preferably all of them (as shown here), a control module MC responsible in particular for transmitting to routers Ni′ that have to participate in connecting paths information that is useful for programming the reservation of the resources necessary for setting them up in the future and using them in the future.

To be more precise, the control module MC of each input router (here router N1) is responsible for two operations when it is advised that LSP connecting paths must be initiated. The control module MC may be alerted either by its own router Ni if it decides to initiate LSP connecting paths itself or by a network manager, for example via the network management system (NMS) of the network R.

The first operation consists in forming intervals of use Ik for each connecting path LSPk that will have to be set up between its node (here node N1) and at least one output node (for example node N3 or N4). To do this, the control module MC uses time information supplied to it for each connecting path LSPk of which its router constitutes the source, namely its (required or intended) set-up time of day and its duration of use.

An interval of use Ik may be defined by a setting up time of day and an end of use time of day or by a setting up time of day and a duration of use. Those times of day are fixed relative to a reference clock that is used to synchronize the internal clock in each router Ni of the network R, for example.

The second operation consists in commanding (or instructing) the signaling module MS to send the routers Ni that have to participate in each of the connecting paths LSPk that will have to be set up signaling messages containing the connection identifiers of the connecting paths LSPk in which they will have to participate and programming data representing their respective intervals of use Ik. These signaling messages request the routers Ni to prereserve (or reserve in advance or program) the resources at the level of their control plane needed to set up the connecting paths LSPk in which they will have to participate, as a function of the corresponding intervals of use Ik.

As indicated hereinabove, the programming data is transmitted by means of signaling messages conforming to the RSVP-TE signaling protocol, for example. To be more precise, the programming data may be integrated into one of the existing objects contained in standard signaling messages, for example, such as the SESSION_ATTRIBUTE object of Path messages. Alternatively, a new object dedicated specifically to programming data may be added to the standard signaling messages. An additional object of this kind might be labeled “Reservation_time”, for example.

Signaling messages being usually transmitted step by step, i.e. router by router (or “hop by hop”), a single signaling message is generally sufficient for a source router (here router N1) to request the other routers that will have to participate in a given connecting path LSPk to prereserve the resources needed to set up that connecting path LSPk.

Resources are prereserved locally by the control module MC of each router Ni that will hove to participate in a connecting path LSPk, whether as source, output or intermediary router. This entails determining locally the range of use Pk of each connecting path LSPk in which the router Ni concerned will have to participate, taking into account corresponding programming data and local resources available at any given time.

It is important to note that the ranges of use Pk assigned locally to a plurality of different connecting paths LSPk may at least partially overlap in time provided that sufficient resources are available locally to support those connecting paths.

The data representing the ranges of use Pk determined by the control module MC of a router Ni is stored in the memories S1 and/or S2, for example, in which it may be integrated into the data structures of the signaling protocol (for example into the “Path State Block” or “Resv State Block” field or some other field).

FIG. 2 represents by way of illustrative and nonlimiting example the time distribution (t) of ranges of use Pk (here k=1 to 4, but k can take any non-zero value) of connecting paths LSPk determined by the control module MC of a router (for example router N2).

This example of time distribution corresponds to the situation set out in the table below:

| | Start of range (†) | End of range (†) | Priority level |
|---|---|---|---|
| I1(LSP1) | 0 | 2 | 0 |
| I2(LSP2) | 3 | 5 | 0 |
| I3*(LSP3) | 4 | 6 | 1 |
| I4(LSP4) | 6 | 8 | 0 |
| I3(LSP3) | 8 | 10 | 1 |

Here the intervals of use I1 and I4 of the connecting paths LSP1 and LSP4 cause no problems as they do not overlap in time with another interval of use. Consequently, the ranges of use P1 and P4 correspond to the two intervals of use I1 and I4 that have been formed by the control module MC of the input router R1 and transmitted by the latter's signaling module MS.

On the other hand, there is a partial overlap of the intervals of use I2 and I3 of the connecting paths LSP2 and LSP3, which were formed by the control module MC of the input router R1 and transmitted to the router N2 (in particular) by the signaling module MS of said input router N1.

If the resources available at the router N2 in the time interval between t=4 and t=5 are sufficient for simultaneous use of the connecting paths LSP2 and LSP3, then the control module MC of the router N2 identifies the range of use P2 with the interval of use I2 and the range of use P3 with the interval of use I3. However, this is not the situation here.

In fact, it is considered here that the resources available at the router N2 in the time interval between t=4 and t=5 are insufficient for simultaneous use of the connecting paths LSP2 and LSP3. Consequently, the control module MC of the router N2 must determine for at least one of the connecting paths LSP2 and LSP3 a range of use different from one of the two intervals of use I2 and I3.

This determination of the time scheduling of the ranges of use Pk relative to each other is effected as a function of at least one selected criterion. Numerous criteria may be envisaged.

Accordingly, each control module MC may be made responsible for establishing a hierarchy between connecting paths as a function of at least one selected criterion, for example as a function of a quality of service (QoS) parameter associated with each connecting path. Of the QoS parameters that might be used, there may be cited by way of example the priority level that is generally associated with the user of a connecting path LSPk.

Alternatively, each control module MC may be made responsible for establishing a hierarchy as a function of a criterion in respect of the order of arrival of requests for prereservation of resources at its router Ni. This option may be envisaged in particular if the programming data relating to different connecting paths is transmitted by the source router (here router N1) in different signaling messages (forming resource prereservation requests). As a result, the programming data can in fact be classified as a function of its order of arrival. The criterion can then consist in giving preference to the first data to arrive, to the detriment of data arriving subsequently, or vice-versa.

It will be noted that a plurality of criteria may be used to define the hierarchy of connecting paths LSPk.

In the example shown in FIG. 2 and in the above table, the priority criterion used is the priority level associated with the user of the connecting path LSPk. Here the users of the connecting paths LSP2 and LSP3 have priority levels “0” and “1”, respectively. The “0” level being the higher level, the connecting path LSP2 therefore takes priority over the connecting path LSP3. The control module MC of the router N2 then decides to identify the range of use P2 with the interval of use I2 and to place the range of use P3 of the connecting path LSP3 after the range of use P4 of the connecting path LSP4, for example. Of course, there are many other options based on other criteria.

To determine the time scheduling of the ranges of use Pk relative to each other, each control module MC can use a flow-based queuing algorithm technique, for example the Weighted Fair Queuing (WFQ) technique or the Weighted Random Early Detection (WRED) technique.

It is important to note that in some circumstances one of the nodes Ni (which here are routers) may be unable to prereserve resources for at least one of the connecting paths because it does not conform to the invention, because it has to participate in too many connecting paths or because of a malfunction. In this case, a resource prereservation problem resolution procedure may be provided. One such procedure is defined by dedicated policies. For example, it may be envisaged that the faulty node send the source node an error message, where applicable indicating the origin of the prereservation problem, and that in response to that error message the source node proposes new intervals of use to the nodes that will have to participate in connecting paths.

The control module MC of a label-switched node (or packet-address-switched) node Ni of the invention may take the form of electronic circuits, software (or electronic data processing) modules or a combination of circuits and software.

The invention is not limited to the embodiments of nodes described hereinabove by way of example only and encompasses all variants that the person skilled in the art might envisage that fall within the scope of the following claims.

Thus an example of the use of the invention in label-switched nodes has been described hereinabove. However, the invention is not limited to that type of node. It relates equally to packet-address-switched nodes and more generally to all nodes dedicated to switching in networks that use a mechanism for reservation and distributed management of the use of resources by means of a resource reservation protocol.

There is claimed:

1. A node for a packet-address-switched or label-switched communication network, comprising signaling means adapted to exchange signaling messages with other nodes of said network in order to reserve resources of connecting paths each associated with a connection identifier and beginning at said node, which comprises control means adapted to form intervals of use of connecting paths to be set up between said node and at least one output node of said network and to command said signaling means to transmit to nodes that will have to participate in each of said connecting paths to be set up signaling messages containing connection identifiers of the connecting paths in which they will have to participate and programming data representing their respective intervals of use and requesting them to prereserve resources at the level of their control plane needed for setting up said connecting paths during time ranges that are a function of said intervals of use.

2. A node according to claim 1, wherein said control means are adapted to define programming data representing setting up times of day and end of use times of day of each interval of use relative to a reference clock.

3. A node according to claim 1, wherein said control means are adapted to define programming data representing the required setting up time of day and the duration of use of each interval of use.

4. A node according to claim 1, wherein said control means are adapted, in the presence of connecting paths to be used at least partly simultaneously and in the event of local resources being insufficient for simultaneous use, to set up a hierarchy of connecting paths as a function of at least one selected criterion so as to place said ranges of use relative to each other as a function of said hierarchy of the associated connecting paths.

5. A node according to claim 4, wherein said control means are adapted to establish said hierarchy as a function of a quality of service parameter associated with each connecting path.

6. A node according to claim 5, wherein said quality of service parameter is a priority level associated with the user of a connecting path.

7. A node according to claim 4, wherein said control means are adapted to establish said hierarchy as a function of a criterion as to the order of arrival of said programming data relating to the different connecting paths.

8. A node according to claim 1, wherein said control means are adapted to define said ranges of use by means of a flow-based queuing algorithm technique.

9. A node according to claim 8, wherein said flow-based queuing algorithm technique is selected from a group including the WFQ and WRED techniques.

10. A node according to claim 1, wherein said signaling means are adapted to integrate said programming data into a selected object of a signaling message.

11. A node according to claim 10, wherein said object is selected from a group including at least one pre-existing object and one new dedicated object.
